(19) United States
(12) Patent Application Publication
(10) Pub. No.: US 2026/0252966 A1
(43) Pub. Date: Aug. 27, 2026

(54) METHOD FOR OBTAINING A MACHINE LEARNING MODEL FOR ESTIMATION OF TOTAL ORGANIC CARBON (TOC) FROM HYPERSPECTRAL DATA OF ROCK SAMPLES

(71) Applicants: PETRÓLEO BRASILEIRO S.A. - PETROBRAS, RIO DE JANEIRO (BR); UNIVERSIDADE DO VALE DO RIO DOS SINOS - UNISINOS, São Leopoldo (BR)

(72) Inventors: Andre Luiz Durante SPIGOLON, Rio de Janeiro (BR); Alysson Soares AIRES, São Leopoldo (BR); Luiz Gonzaga Da Silveira JUNIOR, Porto Alegre (BR); Tainá Thomassim GUIMARÃES, São Leopoldo (BR); Leandro TONIETTO, Montenegro (BR); Mauricio Roberto VERONEZ, São Leopoldo (BR); Ygor Massapust ROCHA, Rio de Janeiro (BR)

(73) Assignees: PETRÓLEO BRASILEIRO S.A. - PETROBRAS, RIO DE JANEIRO (BR); UNIVERSIDADE DO VALE DO RIO DOS SINOS - UNISINOS, São Leopoldo (BR)

(21) Appl. No.: 19/544,328

(22) Filed: Feb. 19, 2026

(30) Foreign Application Priority Data
Feb. 27, 2025 (BR) 1020250039141

(51) Int. Cl. G06N 20/00

(52) U.S. Cl. CPC G06N 20/00

(57) ABSTRACT

Method for estimating total organic carbon (TOC) of rock samples in an automated manner and without the use of destructive techniques. The technique obtains hyperspectral data from rock samples and trains and uses machine learning algorithms, among them artificial neural networks (ANN), to estimate TOC based on the obtained hyperspectral data. The method described herein may be applied to rock samples from different sedimentary basins, provided that the algorithms are trained with samples from all basins. The method has been shown to be generalizable to other rock samples belonging to the basin or sedimentary basins used in the training of the algorithms. The method eliminates the subjectivity of the human analyst and optimizes the time and resources expended in conventional TOC estimation.

### RELATED APPLICATION DATA

This application is based on and claims priority to Brazilian Application No. BR 10 2025 003914 1, filed on February 27, 2025, the entire contents of which are incorporated herein by reference.

### FIELD OF THE INVENTION

The present invention falls within the field of geochemistry. More specifically, the present invention relates to methods for estimating the total organic carbon content of rock samples in an automated manner using artificial neural networks.

### BACKGROUND OF THE INVENTION

The determination of total organic carbon (TOC) in source rocks is a crucial analysis for the characterization of source rocks and is often the first step carried out to evaluate the potential of these rocks. A practice that occurs in some geochemical analysis laboratories involves the responsible professional performing a pre-selection of samples of interest for detailed characterization, basing this choice on the type of rock lithology or other characteristics. However, this process has its disadvantages, as the inherent subjectivity of each professional during the pre-classification process can lead to varied interpretations of the selection criteria.

Prior to the proposed invention, the initial characterization of potentially source rocks based on the determination of TOC depended on performing laboratory analyses on all samples. This analytical step is carried out by combustion of the sample, which has been previously ground, in a carbon analyzer with an infrared detector, the result being obtained, for each sample, in an average of 30 to 240 seconds, depending on the equipment used. In addition, the analysis must be carried out by professionals qualified for such function, which requires initial training for sample preparation and equipment operation.

In order to reduce analysis time and the costs involved in the process, it is common for samples to be pre-selected according to their lithology or other characteristics of potential interest, limiting the measurements to a smaller set of samples. However, this prior classification may lead to varied selection criteria, as the process is influenced by the subjectivity of the professional performing such function. In addition, an incorrect selection could directly impact the results obtained, leading to inaccurate conclusions or even erroneous interpretations regarding the set of samples analyzed.

The state of the art of TOC inference from reflectance spectroscopy, focusing on the short-wave infrared (SWIR) region, is addressed by the scientific works of Mehmani et al. (Multiscale characterization of spatial heterogeneity of petroleum source rocks via near-infrared spectroscopy. In: UNCONVENTIONAL RESOURCES TECHNOLOGY CONFERENCE, AUSTIN, TEXAS, 24-26 JULY 2017, 2017. Anals. [S.l.: s.n.], 2017. pages 2539-2543), Rivard et al. (Inferring toc and major element geochemical and mineralogical characteristics of shale core from hyperspectral imagery. AAPG Bulletin, [S.l.], n. 20.180.604, 2018) and Alnahwi et al. (High-resolution hyperspectral-based continuous mineralogical and total organic carbon analysis of the eagle ford group and associated formations in south texas. AAPG Bulletin, [S.l.], v. 104, n. 7, page 1439-1462, 2020).

In Mehmani et al. (2017), the TOC content was modeled from the intensity of the absorption feature near 1,700 nm, related to organic matter. However, the model proposed by the authors was not robust enough to be applicable to other locations with minimal need for recalibration.

The study by Rivard et al. (2018) proposed an approach that used more than one spectral variable to predict TOC, these values being derived from the wavelet decomposition of reflectance curves at wavelengths of 2174, 2236 and 2392 nm. From a multiple linear regression, the authors proposed a model whose performance for TOC values below 10% resulted in a coefficient of determination (R²) of 0.61.

Finally, the method proposed by Alnahwi et al. (2020) explores an initial step of rock classification with similar minerals (or mineral associations) using a type of unsupervised artificial neural network, called a self-organizing map (SOM). After this process, TOC data were used to calibrate multivariate linear regression models for each established class.

However, these studies were limited to exploring only traditional data correlation techniques, such as linear regression, in modeling the mentioned parameters.

### STATE OF THE ART

Document US2022290553A1, entitled “REAL-TIME MULTIMODAL RADIOMETRY FOR SUBSURFACE CHARACTERIZATION DURING HIGH-POWER LASER OPERATIONS”, discloses a method that includes: irradiating a target surface with a process beam during a drilling process; in response to irradiation with the process beam, receiving a signal beam that contains scattered light from the target surface, as well as light radiating from the target surface; dividing the signal beam into a first portion in a polarization arm and a second portion in a non-polarization arm; performing, in the polarization arm, a first plurality of polarization-dependent intensity and spectrum measurements of the first portion; performing, in the non-polarization arm, a second plurality of intensity and spectrum measurements of the second portion; and based on applying one or more machine learning techniques to at least portions of (i) the first plurality of polarization-dependent intensity and spectrum measurements and (ii) the second plurality of intensity and spectrum measurements, determining a classification of the target surface.

Document CN116927771A, entitled “Method, device, equipment and medium for predicting total organic carbon data of shale reservoir”, discloses a method, a device, equipment and a medium for predicting total organic carbon data of a shale reservoir. The method comprises the following steps: acquiring initial logging data, actually measured total organic carbon data and sedimentary facies data; performing depth calibration on the logging curve to obtain lithological characteristics corresponding to the initial logging data; based on the sampling depth of the total organic carbon data, acquiring logging data corresponding to each part of the total organic carbon data; merging the lithological characteristics with the logging data to obtain spliced logging data; standardizing the spliced logging data and dividing the standardized spliced logging data and the corresponding total organic carbon data into training data and test data; and establishing a convolutional neural network–bidirectional long short-term memory network model based on the training data, testing the model based on the test data to obtain a shale reservoir total organic carbon data prediction model, and predicting total organic carbon data corresponding to the logging data to be predicted based on the shale reservoir total organic carbon data prediction model.

The document High-resolution hyperspectral-based continuous mineralogical and total organic carbon analysis of the Eagle Ford Group and associated formations in south Texas (Alnahwi et al., 2020) discloses that three different cameras within the hyperspectral core imaging system were used to obtain images of a 99.1 m (325 ft) core: (1) a line-scan camera, which produces a high-resolution natural-color red-green-blue photograph (120 mm) of the dry core from the visible light spectrum; (2) a short-wave infrared (SWIR) spectrometer (resolution of 300–500 mm); and (3) a long-wave infrared (LWIR) spectrometer (resolution of 300–500 mm). A self-organizing map neural network was used to classify the samples, and conventionally obtained TOC data were used to train and calibrate the neural network.

### SUMMARY OF THE INVENTION

The present invention discloses a method for estimating total organic carbon (TOC) of rock samples in an automatic manner and without using destructive techniques, comprising the steps of: (1) collecting rock samples; (2) collecting at least one hyperspectral data from each of the rock samples collected in step (1); (2.1) spectral smoothing of the spectral data collected in step (2); optionally (2.2) selecting the spectral range of interest; (2.3) highlighting absorption features and removing the continuum from the spectral data; optionally (2.4) calculating the average of the spectral signatures per sample; (2.5) selecting input variables for the machine learning models; (3) laboratory acquisition of TOC data from the rock samples collected in step (1); (4) associating the hyperspectral data with the respective rock samples and with the TOC data obtained in step (3), obtaining a dataset; (5) dividing the dataset into training data and test data; (6) normalizing the training data; (7) selecting one or more machine learning algorithms and defining their hyperparameters; (8) adjusting the hyperparameters to obtain a machine learning model for each of the tested algorithms; (9) training and estimating the error of the machine learning models obtained in step (8); (10) normalizing the test data; (11) testing the machine learning models trained in step (9) using the test dataset; (12) comparing the results of the tests carried out in step (11); and (13) selecting the machine learning model with the best result based on step (12).

### BRIEF DESCRIPTION OF THE DRAWINGS

The present invention will be described below with reference to the typical embodiments thereof and also with reference to the attached drawings, wherein:

FIG. 1A illustrates a comparative scatter plot between actual and predicted TOC values by an ANN/MLP model in the validation step according to a first example of the present invention.

FIG. 1B illustrates a comparative scatter plot between actual and predicted TOC values by an ANN/MLP model in the test step according to the first example of the present invention.

FIG. 1C illustrates the actual and predicted TOC profiles of core SF-02 according to the collected depth according to the first example of the present invention.

FIG. 2A illustrates a comparative scatter plot between actual and predicted TOC values by an ANN/MLP model in the validation step according to a second example of the present invention.

FIG. 2B illustrates a comparative scatter plot between actual and predicted TOC values by an ANN/MLP model in the test step according to the second example of the present invention.

FIG. 2C illustrates the actual and predicted TOC profiles of core SF-02 according to the collected depth according to the second example of the present invention.

FIG. 3 illustrates the flowchart of the methodology according to the present invention.

### DETAILED DESCRIPTION OF THE INVENTION

Specific embodiments of the present disclosure are described below. In an effort to provide a concise description of these embodiments, not all features of an actual implementation may be described in the specification. It should be appreciated that in the development of any actual implementation, as in any engineering or design project, numerous implementation-specific decisions must be made to achieve the developer specific objectives, such as compliance with system-related and business-related constraints, which may vary from one implementation to another. Furthermore, it should be appreciated that such a development effort may be complex and time-consuming, but would nevertheless be a routine undertaking of design and fabrication for those skilled in the art having the benefit of this disclosure.

The proposal of the present invention consists of a method for estimating the total organic carbon content (TOC) in rock samples by means of spectral analysis of said samples. Such samples may be hand samples or drilling cores. The spectral analysis is performed by a spectroradiometer enabled for absolute reflectance measurement on the rock surface in the spectral range from 1200 to 2400 nm. Preferably, the spectroradiometer should have its own light source, have a spectral resolution of up to 8 nm, and perform calibration using a Spectralon® reference plate. For example, the Spectral Evolution SR 3500 device is considered suitable for carrying out the present invention.

The inventors realized that the spectral data obtained by the spectroradiometer can be correlated with the TOC content of the rock samples. Machine learning models were specifically trained to recognize the patterns of the spectra obtained from the rock samples and, thus, estimate the TOC of each sample. Several types of algorithms, among them artificial neural networks (ANN), were tested to establish which was the most suitable for the task. Subsequently, the selected algorithm was trained with real spectral data obtained by the spectroradiometer and TOC data obtained by a conventional carbon analyzer with an infrared detector, such as Leco SC-144DR. With this, a model was obtained for estimating TOC from spectral data obtained from any rock sample.

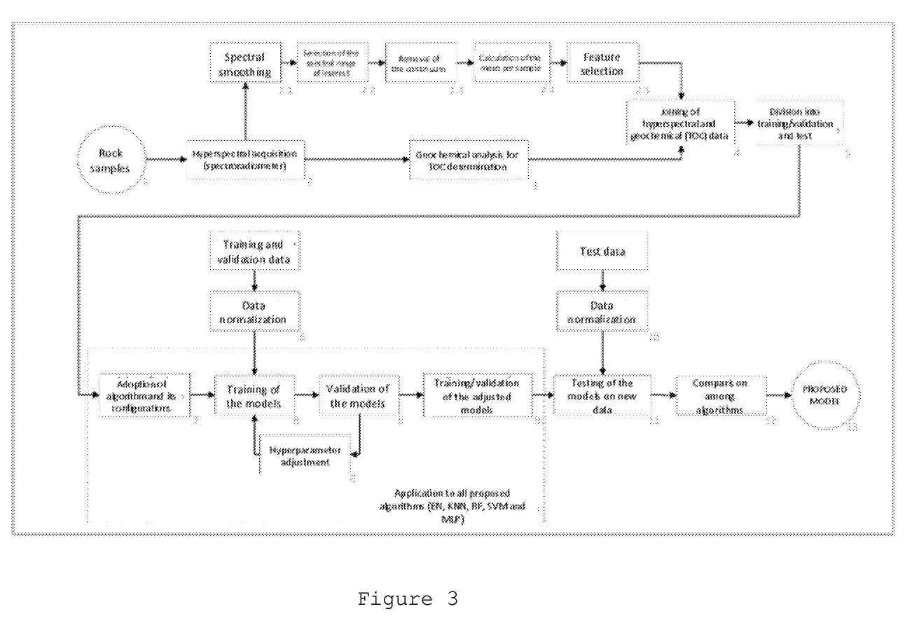

The steps of the methodological workflow for obtaining the model are described below, with reference to FIG. 3:

### 1. Sample collection at the study site

Due to the complexity of the problem and the high dimensionality of the data, a minimum quantity of 50 representative samples is advisable so that the machine learning experiments can be carried out effectively and the results are reliable.

### 2. Hyperspectral acquisition

Acquisition of the spectral signature of the samples with a spectroradiometer, it being recommended, if possible, the measurement of reflectance at more than one point on the sample. If the samples are extracted from drilling cores, it is important that the measurements be recorded according to the depth of collection, so that these data can be correlated with the geochemical data. This step is followed by five sub-steps, as seen below. It is understood that the data pre-processing techniques that will be presented below are, in a broad manner, well known in the state of the art, so that it is not necessary to dwell on details that are routine to the person skilled in the art.

### 2.1. Hyperspectral data pre-processing – Spectral smoothing

To reduce the noise inherent to the collected data, the application of a spectral smoothing algorithm is required. In this case, preferably and without limitation, the initial step of the Savitzky–Golay filter is used, which consists of fitting the data to a second-order polynomial, this fitting being calculated point by point and considering three points: the point to be smoothed, the previous one, and the subsequent one.

### 2.2. Hyperspectral data pre-processing – Selection of the spectral range of interest

If the spectroradiometer used for hyperspectral acquisition performs readings over a spectral range larger than between 1200 and 2400 nm, cropping shall be performed so that the dataset includes only this range. This step may be dispensed with if the spectroradiometer already performs readings within said range.

### 2.3. Hyperspectral data pre-processing – Highlighting of absorption features and removal of the continuum

This approach is widely used in regression-type problems involving spectral data, as it seeks to normalize the reflectance spectra and highlight the absorption features of each spectrum, thus allowing a better comparison among the different spectral curves and their absorption bands. First, the convex hull algorithm (or convex envelope) is applied to the highest reflectance values of the analyzed spectral range to extract the continuum from the curve. Subsequently, the highlighting of the features occurs by division, wherein the reflectance values are converted to a normalized value relative to the continuum of the curve previously calculated.

### 2.4. Hyperspectral data pre-processing – Calculation of the average of the spectral signatures per sample

If more than one spectral measurement has been performed for the same sample, the mean value among them shall be calculated, so that only one spectral signature is correlated with the TOC geochemical data. For example, multiple measurements may be performed from a large-sized rock core. This step is dispensable in cases in which exactly one spectral sample is obtained from each rock sample.

### 2.5. Selection of input variables (features) for the machine learning models

Select the processed reflectance values after removal of the continuum in sub-step 2.3 relative to the wavelengths: 1412, 1729, 1750, 1768, 1909, 2207, 2271, 2310, 2333, 2350 nm. The selection of wavelengths considers an approach based on domain knowledge, with inclusion of central positions of absorption features of the constituent materials of these rocks (organic fraction – 1729, 1768 and 2310 nm; clay minerals and molecular water – 1412, 1909 and 2207 nm; and carbonate minerals – 2350 nm) and, for those features with close locations, a wavelength between these features (1750, 2271 and 2333 nm). It should be noted that depending on the spectral resolution of the sensor used, these wavelengths may undergo small variations (for example, not having a spectral reading specifically at the wavelength of 1412 nm but rather at 1410 or 1420 nm), requiring the selection of the spectral bands closest to the 10 aforementioned wavelengths. To support this adjustment, the behavior of the spectral response of the samples may be observed and, thus, the wavelength that best corresponds to the characteristic absorption features mentioned may be selected.

### 3. Laboratory analysis for determination of TOC

This step may be carried out, for example, by combustion in a carbon analyzer with an infrared detector (destructive analysis), such as Leco SC-144DR. As with hyperspectral acquisition, it is important that the geochemical data be assigned to the sample or depth at which measurements were performed with the spectroradiometer.

### 4. Joining of the collected datasets

Associate the hyperspectral dataset, that is, the 10 spectral variables obtained in sub-step 2.5, with the respective geochemical TOC content data of each sample.

### 5. Division of the dataset into training/validation and test

At this step, the spectral data and their associated TOC and depth data shall be divided into a training dataset and a validation dataset for training the machine learning models. Preferably, a random division of 80% of the dataset is performed for carrying out the training and validation steps of the predictive models, with the remaining 20% being reserved for testing the trained models and evaluating the generalization capability of the models to a new dataset. The training and validation of machine learning models are well understood in the art, such that a person skilled in the art will be able to make adaptations to meet specific needs or criteria without departing from the scope of the present invention.

### 6. Standardization/normalization of the training and validation data

Process of preparing the data so that the dataset is within a common range for the machine learning step. Therefore, the spectral data were set to zero mean and unit standard deviation, and the TOC data were rescaled to the range between zero and one.

### 7. Adoption of the machine learning algorithm and definition of the hyperparameters to be adjusted

For application of the methodological workflow proposed in this invention, algorithms from different areas within machine learning should be explored, since they have their respective ways of approaching the problem. Thus, the defined machine learning algorithms are: Elastic Net (EN), K- Nearest Neighbours (KNN), Random Forest (RF), Support Vector Machine (SVM), and a neural network of the Multi-Layer Perceptron (MLP) type. Plainly, any other machine learning algorithm considered suitable, whether known or yet to be developed, may be used without departing from the scope of the present invention. The hyperparameter grid to be explored for tuning the algorithms mentioned above is:

EN: (a) alpha: 0 to 1.0; (b) l1_ratio: 0 to 1.0.

KNN: (a) n_neighbors: 1 to 9; (b) metric: Manhattan, Euclidean, Chebyshev, Angular; (c) weights: uniform, distance.

RF: (a) n_estimators: 10 to 500; (b) criterion: squared_error, absolute_error, poisson; (c) mean_samples_leaf: 1, 2or 3; (d) ccp: 0, 1, 10 or 100.

SVM: (a) C: 0.0005 to 100; (b) kernel: linear, rbf, poly; (c) degree: 2 to 6; (d) gamma: auto, scale.

MLP: (a) hidden_layer_sizes: 2or 3 layers, with 5 to 200 neurons in each; (b) alpha:0.0001 to 0.1; (c) learning_rate: constant, adaptive; (d) learning_rate_init: 1e-05 to 0.01; (e) batch_size: 1 to 10.

### 8. Hyperparameter tuning

This step consists of a sequence of training and validation steps of models with different model configurations. As an approach for hyperparameter optimization, the Bayesian search algorithm is used, which, based on the searches performed, selects only the relevant search space and discards intervals that are likely not to provide the best solution. A maximum value of 1000 executions/searches is adopted, stopping the experiment when this limit is reached for classifiers such as MLP, while in the case of algorithms with fewer hyperparameter combinations, such as KNN, the search ends when all possibilities are exhausted. In this manner, 1000 models are generated and the tuning is performed so that the value of the performance metric Mean Squared Error (MSE) is as small as possible. As a validation strategy, 10-fold cross-validation is used, it being important that the rock samples data be shuffled before the start of the process, so that the folds do not represent grouped depth ranges. The training is carried out in such a manner that a machine learning model for TOC estimation is obtained for each of the machine learning algorithms selected in step 7.

### 9. Training and error estimation of the models

A new step of training and validation of the machine learning models with the best hyperparameter configuration for each algorithm (one model for each of the five adopted machine learning algorithms). The same training/validation dataset defined in step 5 and standardized in step 6 shall be used. The cross-validation strategy (10-fold cross-validation) is also adopted. In order to interpret how well the estimates of each trained model were in comparison with the reference values (measured TOC), during the validation step the following performance metrics shall be computed: coefficient of determination (R2), MSE and mean absolute error (MAE), as well described in the art.

### 10. Standardization/normalization of the test data

A step similar to step 6, which shall consider as normalization parameters the same ones that were applied to the training/validation dataset.

### 11. Testing of the models on the test dataset

The models trained and validated in step 9 are applied to a new dataset for testing. This test dataset was obtained in step 5. By analyzing the behavior of the selected models when handling with data different from those on which they were trained, it is possible to obtain information about the predictive and generalization capability of these algorithms, as well as to perceive, for example, whether overfitting (that is, overfitting of the model to the training data) occurred. If all models fail in this regard, it is necessary to return to step 8 for selection of a new set of hyperparameters.

### 12. Comparison among the five generated models

Evaluation of the results of the R², MSE and MAE metrics calculated in the validation and test steps of the models for selection of the algorithm that best modeled the proposed problem (TOC prediction) with the selected data. For this selection of the ideal model, the following criteria shall be considered: the chosen model shall present a high R² in all steps (training, validation and test), being greater than 0.9 for training and 0.7 for validation and test, thus indicating good explanation of the variability of the data; in addition, the error values (MSE and MAE) shall be lower to ensure more accurate and robust predictions, preferably being below 2 to 3% (in TOC percentage). If these conditions occur in more than one of the five trained and tested machine learning models, the selected model should ideally present the highest R² value, mainly in the validation and test steps, and the lowest error values (MSE and MAE). The threshold values suggested above for R², MSE and MAE are preferential, but not limiting. Particular applications may have different threshold values without departing from the scope of the present invention. As these conditions may not occur simultaneously for the same model, the operator may opt for the model with the highest R² value in the test step or optionally perform a subjective selection considering all calculated metrics. If none of the models meets the established conditions, it shall be necessary to return to step 8.

### 13. Proposed model

Based on the comparison of step 12, a final model is selected to be applied to new hyperspectral data for indirect and non-destructive estimation of TOC.

The method described above may be repeated as desired to seek an even more appropriate model. However, it should be noted that the geochemical characteristics of rocks may vary greatly between different locations. In this sense, it is vital that the methodological workflow illustrated above be repeated for each new region to be investigated, for example, new sedimentary basins. In other words, a model generated with data from a given area should not be applied to another distinct area. In this manner, the geochemical and hyperspectral datasets used in the training of the machine learning models will be representative of these new areas.

### Examples of the invention

For purposes of demonstrating results of application of the method proposed in this invention, two distinct examples are presented:

Example 1 – derived from modeling of TOC content considering samples from only one study area;

Example 2 – includes samples collected from two sedimentary basins, therefore the generated model tends to be generalizable to both.

The first example provides for application of the method for generation of a local-level predictive TOC model, since geochemical and hyperspectral data originating from a single study site were used, the outcrop of Sociedade Extrativa Santa Fé (Tremembé/SP), representative of the Tremembé Formation, of the Taubaté Basin. In this sense, it was sought to validate the method and its capacity to generate robust models that may be extrapolated to different targets within the same geological context. Therefore, for training and validation of the machine learning models, information from 54 samples collected from a core extracted at the site, designated SF-01, was used. Evaluation of the generalization capability of the trained models was carried out by applying them to a new dataset, with 21 samples from a second core collected at the same site (SF-02). In this dataset used, the TOC content of the samples ranged between 0.34 and 22.8%, with a mean of 4.71%.

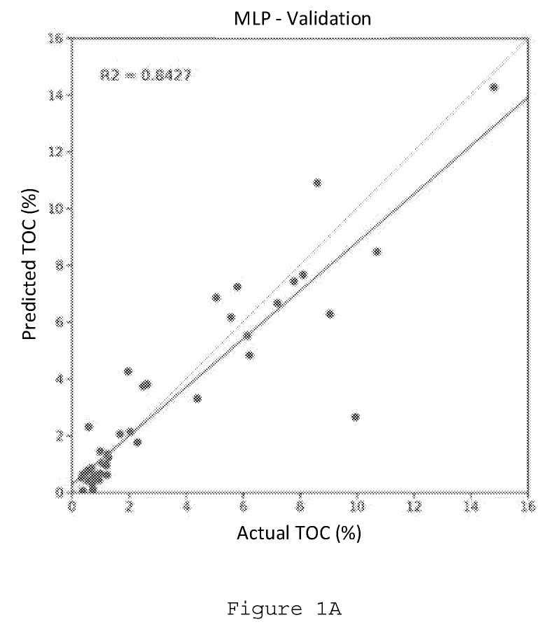

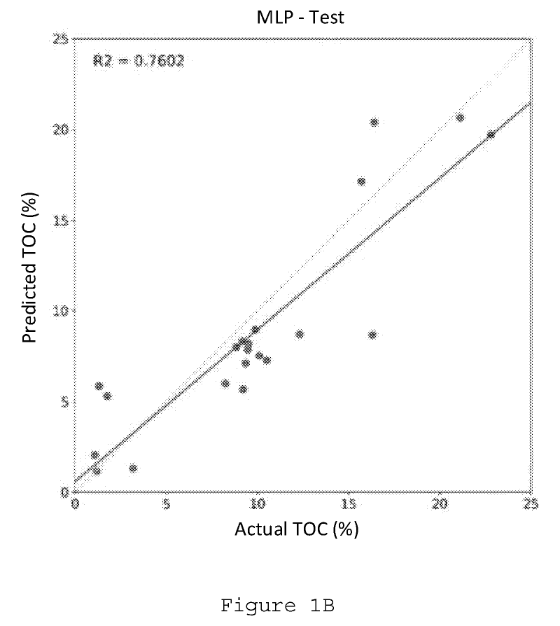

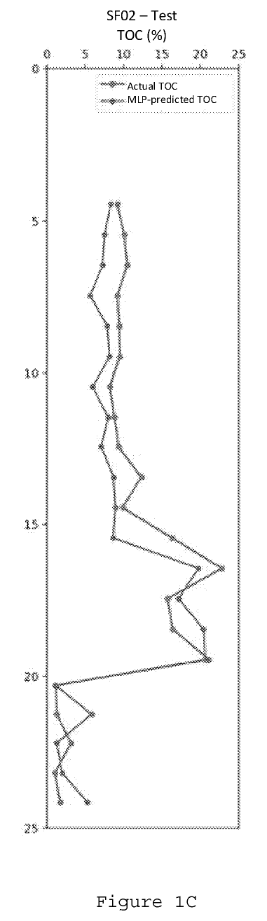

After application of the methodological workflow of the present invention to the aforementioned dataset, among the five machine learning algorithms explored (EN, KNN, RF, SVM and MLP), the MLP neural network achieved the best results, with a coefficient of determination (R²) of 0.99 in model training, 0.84 in its validation and 0.76 in the test step on the second collected core. The Mean Absolute Error (MAE) calculated was equal to 0.70% in the validation step and 2.4% during testing (values relative to the same unit of the variable, that is, in TOC percentage). FIGS. 1A, 1B and 1C demonstrate these results, wherein FIGS. 1A and 1B illustrate comparative scatter plots between the actual and predicted TOC values by the MLP model in the validation and test steps, respectively, and FIG. 1C illustrates the actual and predicted TOC profiles of core SF-02 according to the collected depth.

Example 2 is a demonstration of application of the method of the present invention to samples from distinct study areas. The method was applied to a dataset with 110 samples originating from two distinct sedimentary basins: the Taubaté Basin and the Araripe Basin. The objective of this application was to generate predictive models that were generalizable among different study areas, in this case originating from the two aforementioned basins, and that could be used to increase geochemical information from the study areas, considering that hyperspectral data acquisition was performed in a greater quantity than the geochemical acquisition. These data were collected from six drilling cores: two extracted near the outcrop of Sociedade Extrativa Santa Fé (Tremembé/SP), representative of the Tremembé Formation, of the Taubaté Basin, and the other four originating from the Crato, Ipubi and Romualdo Formations, of the Araripe Basin, one collected at Pedreira Três Irmãos (Nova Olinda/CE) and three at Mineração São Jorge (Trindade/PE). The TOC concentration in the samples analyzed in this application ranges from 0 to 26%, with a mean of 4.12%.

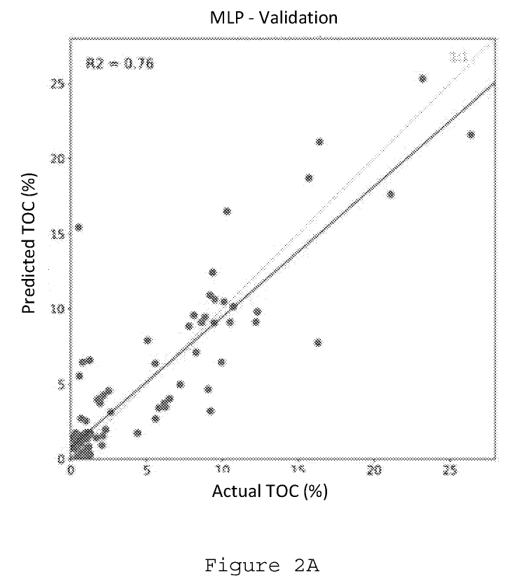

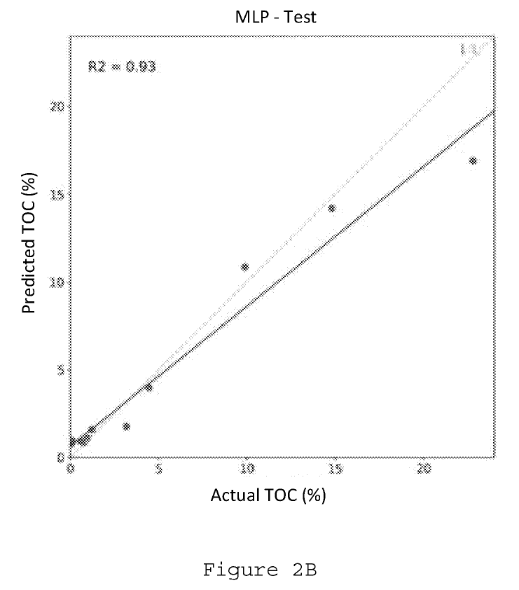

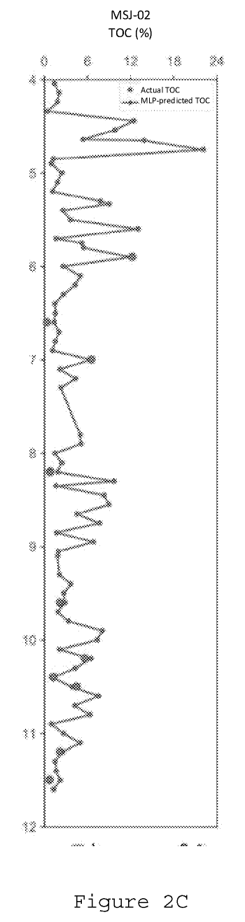

The machine learning algorithm that best modeled the TOC content in the analyzed dataset was the MLP-type neural network, with a coefficient of determination (R²) of 0.96 in model training, 0.76 in its validation and 0.93 in the test step on data extracted from the set for subsequent evaluation of the predictive capability of the models. The MAE error statistic in validation was equal to 1.64% and in test 1.09%, representing that in this case the incorrect prediction by the model did not exceed, on average, 2% TOC. The results are illustrated in FIGS. 2A, 2B and 2C in FIG. 2, wherein FIGS. 2A and 2B illustrate comparative scatter plots between the actual and predicted TOC values by the MLP model in the validation and test steps, respectively, and FIG. 2C illustrates the actual and predicted TOC profiles of core MSJ-02 according to the collected depth.

It is important to highlight the demonstration of another notable applicability and advantage of the proposed method: the infilling of information between discrete laboratory samplings, which can be observed in FIG. 2C. In the TOC data profile presented in the figure, there are 10 discrete data points between depths of 4 and 12 m, where samples were collected and laboratory analyses were performed. With application of the method, from the MLP model approximately 70 TOC estimates were obtained for the same interval, therefore providing a prediction of the behavior of this variable between the laboratory samplings.

From the results presented, it is possible to perceive the potential of the method of the present invention for indirect preliminary characterization of potentially source rock samples. In the TOC profiles presented in FIGS. 1A, 1B, 1C, 2A, 2B and 2C, it is observed that the behavior of the TOC predicted by the neural network was similar to the real data, following the trends of decrease and increase along the core.

The advantages of the present invention will be immediate to those skilled in the art, among which the following may be highlighted: the present invention, proposed in the form of a means for estimating TOC from hyperspectral data, minimizes the difficulties of the state of the art identified in the performance of laboratory analyses for this purpose, since spectroscopy constitutes a non-destructive approach for preliminary characterization of source rocks. This means that the samples remain intact after analysis, allowing their preservation and the possibility of future more detailed analyses. In this manner, only samples with estimated organic matter concentrations (TOC) above a certain established threshold, considering the uncertainties of the applied model, would be selected for more precise and detailed quantitative laboratory investigations, such as geochemical, petrophysical analyses, among others. The uncertainties of the proposed model are directly related to the model performance metrics (R², MSE and MAE), which indicate the margin of error associated with the TOC estimates. These uncertainties may vary significantly, influenced by the characteristics of the samples, homogeneity of the dataset and the complexity and limitations of the machine learning algorithms used. To deal with these uncertainties in the selection of samples for more detailed quantitative analyses, it is necessary to consider an appropriate confidence interval, which incorporates the margin of error of the model, to ensure that the estimated TOC concentrations are above the selection threshold. This process avoids the selection of samples with values that may have been overestimated by the model and ensures greater reliability in the screening process for subsequent investigations. It is also emphasized that the technique used (hyperspectral data acquisition with a spectroradiometer) does not require sample preparation, with measurements being performed directly on the surface of the rock in natura. n addition, the equipment used is easy to handle and the readings are performed in less than 10 seconds, allowing the acquisition to be carried out quickly and efficiently. Therefore, once the machine learning model that best corresponds to the dataset has been trained, the time between collection of the spectral data, pre-processing thereof and subsequent insertion into the model for TOC prediction is significantly shorter than that required for a laboratory analysis.

The capability of applying the models generated from the proposed methodological workflow to hyperspectral images also overcomes the limitation of spatial resolution of geochemical data originating from point samplings of outcrops or cores. Thus, the TOC content could be analyzed with respect to its spatial distribution in these targets, allowing a broader understanding of this parameter, which is so important in the geochemical characterization of organic-matter-rich rocks.

The method described herein facilitates the daily activities of geologists and geoscientists, whether in industry or academia, both in the field and in the laboratory, as it allows rapid obtaining of inferences regarding the amount of organic matter in source rocks without the need for laboratory analysis.

The predictive model generated from the proposed method may function as an initial filter to select representative samples for more detailed geochemical analyses, which saves time, reduces costs and increases the efficiency of the characterization process of these rocks. This characteristic may also be useful for characterization of cores that have tens to hundreds of meters, serving to fill gaps between discrete and spaced geochemical data. In this manner, in laboratories whose resources for laboratory analyses are scarce, it would not be necessary to classify potential samples by a professional, since the acquisition of hyperspectral data and its subsequent insertion into the trained model would allow obtaining a TOC estimate, which would serve as a decision criterion for the required selection.

The capability of extrapolating these models to hyperspectral images further expands the potential of the method, considering that it would allow acquisition of images of several samples or cores for their preliminary characterization, or even its application at the outcrop scale. Application of the generated models to hyperspectral images of outcrops allows analysis of the spatial distribution of the TOC parameter in the outcrop and, therefore, may be an important tool for more accurate sampling guidance, thus reducing sampling resources and time and analyses, in addition to avoiding possible errors in the evaluation and characterization of source rocks caused by point sampling.

Although aspects of the present disclosure may be susceptible to various modifications and alternative forms, specific embodiments have been shown by way of example in the drawings and have been described in detail herein. It should be understood, however, that the invention is not intended to be limited to the particular forms disclosed. Rather, the invention is intended to cover all modifications, equivalents and alternatives falling within the scope of the invention, as defined by the following appended claims.

What is claimed is:

1. A method for obtaining a machine learning model for estimation of total organic carbon (TOC) from hyperspectral data of rock samples, the method comprising the steps of:
(1) collecting rock samples;
(2) collecting at least one hyperspectral data from each of the rock samples collected in step (1);
(2.1) spectral smoothing of the spectral data collected in step (2);
(2.3) highlighting absorption features and removing the continuum from the spectral data;
(2.5) selecting input variables for the machine learning models;
(3) laboratory acquisition of TOC data from the rock samples collected in step (1);
(4) associating the hyperspectral data with the respective rock samples and with the TOC data obtained in step (3), obtaining a dataset;
(5) division of the dataset into training data and test data;
(6) normalization of the training data;
(7) selecting one or more machine learning algorithms and definition of their hyperparameters;
(8) hyperparameter tuning to obtain a machine learning model for each of the adopted machine learning algorithms;
(9) training and error estimation of the machine learning models obtained in step (8);
(10) normalization of the test data;
(11) testing of the machine learning models trained in step (9) using the test dataset, the test comprising calculating R² MSE and MAE of each of the machine learning models trained in step (9);
(12) analyzing the results of the experiments carried out in steps (9) and (11) to determine the values of R² MSE and MAE; and
(13) selecting the machine learning model based on the analysis of the R² MSE and MAE values carried out in step (12).

2. The method according to claim 1, wherein step (2) is performed by a spectroradiometer configured for measuring absolute reflectance on the surface of the rock samples by means of a contact probe with its own light source.

3. The method according to claim 2, wherein the spectroradiometer operates in the range of 1200–2400 nm.

4. The method according to claim 2, wherein if the spectroradiometer operates in a range greater than 1200–2400 nm, the method further comprises, after sub-step (2.1):
(2.2) Selection of the spectral range of interest, wherein sub-step (2.2) comprises cropping the operating range so that the spectral data obtained are comprised only within the range between 1200–2400 nm.

5. The method according to claim 1, wherein if two or more hyperspectral data are obtained per sample in step (2), the method further comprises, after sub-step (2.3):
(2.4) Calculation of the average of the spectral signatures per sample.

6. The method according to claim 1, wherein sub-step (2.5) comprises selecting the processed reflectance values relative to wavelengths equal to 1412, 1729, 1750, 1768, 1909, 2207, 2271, 2310, 2333, and 2350 nm.

7. The method according to claim 1, wherein step (3) uses a destructive technique performed by a carbon analyzer with an infrared detector.

8. The method according to claim 1, wherein the machine learning algorithms are Elastic Net, K-Nearest Neighbours, Random Forest, Support Vector Machine, and Multi-Layer Perceptron.

9. The method according to claim 1, wherein selecting the machine learning model comprises selecting the model whose R² value has been calculated as greater than 0.9 in step (9) and greater than 0.7 in step (11), and whose MSE and MAE values have been below 2% in TOC value in steps (9) and (11).

10. The method according to claim 9, wherein if more than one model meets the conditions, the model with the highest R² value in step (11) is selected.

11. The method according to claim 9, wherein selection of the model includes an operator manually selecting the model.
